(19) United States
(12) Patent Application Publication
(10) Pub. No.: US 2026/0219556 A1
(43) Pub. Date: Jul. 30, 2026

(54) Rear Optical Device, Assembly Forming a Modular Zoom, and Method for Changing the Zoom of a Camera Lens

(71) Applicant: THALES, Meudon (FR)

(72) Inventors: Guillaume DUBOIS, Saint Heand (FR); Dominique CHERVIN, Saint Heand (FR); Bruno COUMERT, Saint Heand (FR)

(21) Appl. No.: 19/143,573

(22) PCT Filed: Dec. 29, 2023
(86) PCT No.: PCT/EP2023/087963

§ 371 Date: Jun. 26, 2025

(30) Foreign Application Priority Data
Dec. 30, 2022 (FR) 2214701

(51) Int. Cl. G03B 17/12; H04N 23/45; H04N 23/55

(52) U.S. Cl. CPC G03B 17/12; H04N 23/55; H04N 23/45

(57) ABSTRACT

Disclosed is a rear optical device (14A, 14B) intended to form an image depending on an optical flux captured by a front optical device (12), the rear optical device (14A, 14B) comprising
a housing (22A, 22B) comprising a sensor (26A, 26B) defining an image format, and
a coupling unit (24A, 24B) intended to removably couple the housing (22A, 22B) to a front optical device (12) to form a zoom (18A, 18B), the coupling unit (24A, 24B) being formed of a nut (30A, 30B).

The present invention relates to a rear optical device intended to form an image based on an optical flux captured by a front device, an assembly forming a modular zoom, and a method for changing the zoom of a camera lens.

Generally, a zoom of a cinematographic camera lens is adapted to be used with a specific sensor size to provide an image in a given format.

It is possible to set up accessories, such as converters, to adapt the zoom for forming an image of another format.

However, the use of such converters results in a significant loss of quality and also an increase in bulk.

To overcome these drawbacks, it is known, notably from document FR3060771A1, to use a modular optical system comprising a front optical device designed to capture an optical flux and a plurality of rear optical devices, each intended to form an image based on an optical flux captured by the front optical device in a given format. The coupling of the common front device and a rear optical device forms a zoom adapted to a specific image format.

Each rear optical device is composed of numerous sub-elements, such as the housing comprising the sensor specific to the image format, the iris diaphragm, the indexing ring, the focal engraving ring, and the focusing ring.

However, changing a zoom adapted to one specific format to another is relatively complex. It is necessary, for example, to disassemble each sub-element forming the first rear optical device, then reassemble each sub-element forming the second rear optical device. These disassembly and assembly operations must be carried out in a precise order and generally require many specific tools.

These operations are therefore generally tedious and must be carried out at a dedicated service center.

One of the aims of the invention is to improve this solution and propose an optical assembly allowing the image format to be modified simply, quickly, and without specific tools, while maintaining good image quality.

To this end, the invention proposes a rear optical device intended to form an image based on an optical flux captured by a front optical device, the rear optical device comprising:
a housing comprising a sensor defining an image format, and
a coupling unit intended to removably couple the housing to a front optical device to form a zoom, the coupling unit being formed of a nut.

According to a particular implementation mode, the nut is a notched nut.

The invention also relates to an assembly forming a modular zoom comprising:
a front optical device designed to capture an optical flux,
a first rear optical device as described above, the coupling by the nut of the first rear optical device and the front optical device forming a first zoom, and
a second rear optical device as described above, the coupling by the nut of the second rear optical device and the front optical device forming a second zoom.

According to particular implementation modes, the assembly comprises one or more of the following optional features, taken individually or in any technically possible combinations:
the image format of the sensor of the first rear optical device is different from that of the second rear optical device;
the front optical device comprises an iris diaphragm and an indexing ring designed to adjust the diaphragm's aperture, the iris diaphragm and the indexing ring being common to the first zoom and the second zoom;
in the first zoom, the diaphragm of the front optical device is at a first distance from the sensor of the first rear optical device, in the second zoom, the diaphragm of the front optical device is at a second distance from the sensor of the second rear optical device, the first distance and the second distance being substantially equal;
the indexing ring is movable between a first configuration adapted for adjusting the diaphragm's aperture of the first zoom and a second configuration adapted for adjusting the diaphragm's aperture of the second zoom; and
the front optical device comprises a focal engraving ring, the focal engraving ring being common to the first zoom and the second zoom, the focal engraving ring being movable between a first configuration adapted for adjusting the focal length of the first zoom and a second configuration adapted for adjusting the focal length of the second zoom.

The invention also relates to a method for changing the zoom of a camera lens comprising the following steps:
providing an assembly as described above, the front optical device being coupled to the first rear optical device to form the first zoom,
rotating the nut of the first rear device to release the first rear optical device from the front optical device, and
placing the second rear device on the front optical device and rotating the nut of the second rear optical device to couple the front optical device to the second rear optical device and form the second zoom.

According to a particular implementation mode, the front optical device comprises an iris diaphragm and an indexing ring, the method comprising an additional step of rotating the indexing ring of the front optical device from a first configuration adapted for adjusting the diaphragm's aperture of the first zoom to a second configuration adapted for adjusting the diaphragm's aperture of the second zoom and/or the front optical device comprises a focal engraving ring, the method comprising an additional step of translating the focal engraving ring of the front optical device from a first configuration adapted for adjusting the focal length of the first zoom to a second configuration adapted for adjusting the focal length of the second zoom.

The invention and its advantages will be better understood by reading the following description, given solely as a non-limiting example, and made with reference to the appended drawings, wherein:

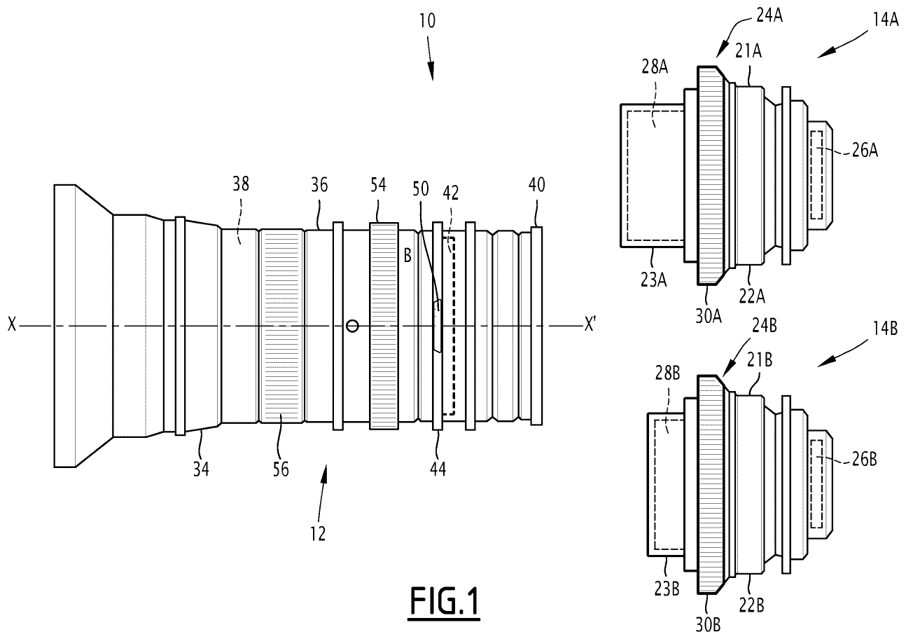

FIG. 1 is a schematic representation of an assembly forming a modular zoom according to the invention;

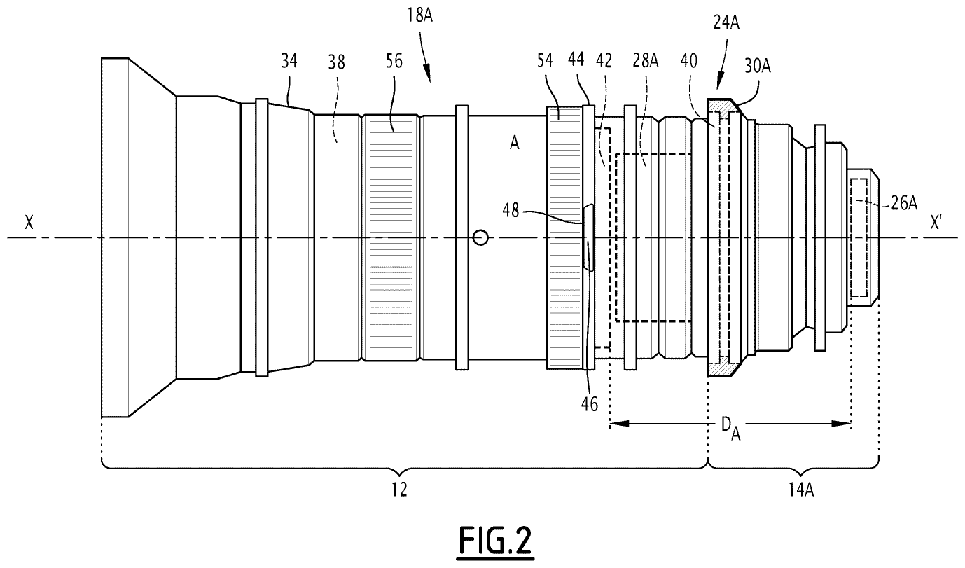

FIG. 2 is a schematic representation of a first zoom formed by the assembly of FIG. 1; and

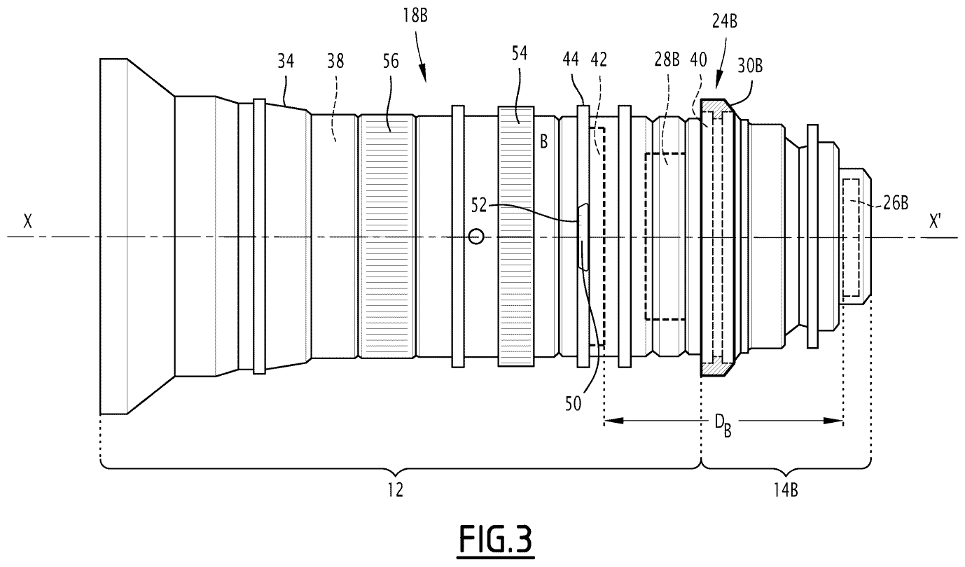

FIG. 3 is a schematic representation of a second zoom formed by the assembly of FIG. 1.

FIG. 1 illustrates an assembly 10 forming a modular zoom, and in particular a zoom of a cinematographic camera lens.

The assembly 10 comprises a front optical device 12 designed to capture an optical flux, a first rear optical device 14A, and a second rear optical device 14B.

The assembly 10 forms a first zoom 18A illustrated in FIG. 2 by the coupling of the front optical device 12 and the first rear device 14A.

In the first zoom 18A, the first rear device 14A is arranged, for example, in continuity with the front optical device 12 along a longitudinal axis X-X′ (corresponding to the optical axis).

The first zoom 18A is, for example, adapted to provide an image in a first image format. The first image format is, for example, the FF format (which is the English abbreviation for “Full Frame”).

The assembly 10 also forms a second zoom 18B illustrated in FIG. 3 by the coupling of the front optical device 12 and the second rear device 14B.

In the second zoom 18B, the second rear device 14B is arranged, for example, in continuity with the front optical device 12 along the longitudinal axis X-X′.

The second zoom 18B is, for example, adapted to provide an image in a second image format.

The second image format is preferably different from the first image format. The second image format is, for example, the S35 image format.

Alternatively, the first image format and the second image format are, for example, chosen from the S35 image format corresponding to a sensor size of 24.89×18.6 mm², the FF image format corresponding to a sensor size of 24×36 mm², and the academic 35 mm format corresponding to a sensor size of 22×316 mm².

We will first describe more specifically the first rear optical device 14A and the second rear optical device 14B.

Each of the first rear optical device 14A and the second rear optical device 14B is intended to form an image resulting from an optical flux captured by the front optical device 12.

More particularly, the first rear optical device 14A is intended to form an image in the first image format, for example, the FF format. The second rear optical device 14B is intended to form an image in the second image format, for example, the S35 image format. Each of the first rear optical device 14A and the second rear optical device 14B comprises a housing 22A, 22B, and a coupling unit 24A, 24B.

The housing 22A, 22B of each of the first rear optical device 14A and the second rear optical device 14B comprises, for example, an outer wall 21A, 21B advantageously defining a housing 23A, 23B, preferably of revolution shape around the longitudinal axis X-X′.

The housing 22A, 22B of each of the first rear optical device 14A and the second rear optical device 14B comprises a sensor 26A, 26B defining an image format.

Each sensor 26A, 26B is preferably housed in the corresponding housing 23A, 23B, for example, at a longitudinal end of the housing 22A, 22B.

More particularly, each sensor 26A, 26B is a digital sensor of substantially rectangular shape. The size of the sensor 26A, 26B defines, for example, the corresponding image format.

For example, the image format of the sensor 26A of the first rear optical device 14A is different from that of the second rear optical device 14B.

In particular, the sensor 26A of the first rear optical device 14A defines the first image format.

In the case where the first image format is the FF format, the sensor 26A of the first rear optical device 14A has, for example, a rectangular shape with a length equal to 36 mm and a width equal to 24 mm.

In particular, the sensor 26B of the second rear optical device 14B defines the second image format.

In the case where the second image format is the S35 format, the sensor 26B of the second rear optical device 14B has, for example, a rectangular shape with a length equal to 24.89 mm and a width equal to 18.6 mm.

The housing 22A, 22B of each of the first rear optical device 14A and the second rear optical device 14B advantageously also comprises optical elements 28A, 28B, in particular fixed lenses housed in the corresponding housing 23A, 23B.

The coupling unit 24A, 24B of each of the first rear optical device 14A and the second rear optical device 14B is intended to removably couple said housing 22A, 22B to the front optical device 12 to form a zoom 18A, 18B.

More particularly, the coupling unit 24A of the first rear optical device 14A is intended to removably couple the housing 22A of the first rear optical device 14A to the front optical device 12 to form the first zoom 18A illustrated in FIG. 2.

Similarly, the coupling unit 24B of the second rear optical device 14B is intended to removably couple the housing 22B of the second rear optical device 14B to the front optical device 12 to form the second zoom 18B illustrated in FIG. 3.

The coupling unit 24A, 24B of each of the first rear optical device 14A and the second rear optical device 14B is formed of a nut 30A, 30B.

Advantageously, the coupling unit 24A, 24B of each of the first rear optical device 14A and the second rear optical device 14B comprises only said nut 30A, 30B.

More particularly, the coupling unit 24A, 24B of each of the first rear optical device 14A and the second rear optical device 14B does not comprise screws. The coupling is therefore achieved without screws.

As illustrated in the figures, each nut 30A, 30B extends, for example, around a portion of the outer wall 21A, 21B of the corresponding housing 22A, 22B.

Preferably, each nut 30A, 30B is rotatable around said outer wall 21A, 21B of the housing 22A, 22B, for example, between a locking position and a free position.

Advantageously, each nut 30A, 30B is a notched nut.

In other words, each nut 30A, 30B comprises an outer face presenting an alternation of notches and grooves, to facilitate the gripping and rotation of the nut 30A, 30B.

We will now describe more specifically the front optical device 12 and its interactions with each of the first rear optical device 14A and the second rear optical device 14B.

The front optical device 12 comprises, for example, a housing 34 comprising an outer wall 36 delimiting a housing 38, in particular of revolution shape around the longitudinal axis X-X′.

The front optical device 12 preferably comprises at least one coupling element 40 designed to cooperate with the nut 30A, 30B of each of the first rear optical device 14A and the second rear optical device 14B.

The coupling element 40 is, for example, arranged on the outer wall 36 of the housing 34.

In particular, the coupling by the nut 30A of the first rear optical device 14A and the front optical device 12 forms the first zoom 18A.

More precisely, the coupling element 40 of the front optical device 12 cooperates, for example, by shape cooperation, with the nut 30A of the first rear optical device 14A in its locking position to fix the housing 22A of the first rear optical device 14A on the front optical device 12 and form the first zoom 18A as illustrated in FIG. 2.

Similarly, the coupling by the nut 30B of the second rear optical device 14B and the front optical device 12 forms the second zoom 18B.

More precisely, the coupling element 40 of the front optical device 12 cooperates, for example, by shape cooperation, with the nut 30B of the second rear optical device 14B in its locking position to fix the housing 22B of the second rear optical device 14B on the front optical device 12 and form the second zoom 18B as illustrated in FIG. 3.

The front optical device 12 preferably comprises optical elements (not illustrated) designed to capture an optical flux, such as at least one group of movable lenses housed in the housing 38.

Advantageously, the front optical device 12 comprises an iris diaphragm 42 and an indexing ring 44 designed to adjust the aperture of diaphragm 42.

Preferably, as visible in the figures, the iris diaphragm 42 and the indexing ring 44 are common to the first zoom 18A and the second zoom 18B.

In particular, in the first zoom 18A illustrated in FIG. 2, the diaphragm 42 of the front optical device 12 is at a first distance D_{A} from the sensor 26A of the first rear optical device 14A. The first distance D_{A} is preferably measured along the longitudinal axis X-X′. Similarly, in the second zoom 18B illustrated in FIG. 3, the diaphragm 42 of the front optical device 12 is at a second distance D_{B} from the sensor 26B of the second rear optical device 14B. The second distance D_{B} is preferably measured along the longitudinal axis X-X′.

Advantageously, the first distance D_{A} and the second distance D_{B} are substantially equal, so that the bulk of the first zoom 18A and the second zoom 18B is substantially identical.

In other words, the difference between the first distance D_{A} and the second distance D_{B} is preferably less than 0.05 mm.

To this end, the optical elements 28A, 28B of each of the first rear optical device 14A and the second rear optical device 14B have been advantageously configured to allow this equality between the first distance D_{A} and the second distance D_{B}.

Preferably, the indexing ring 44 is movable between a first configuration illustrated in FIG. 2 and a second configuration illustrated in FIGS. 1 and 3.

For example, the indexing ring 44 is rotatable around the longitudinal axis X-X′ relative to the housing 34, for example, by a rotation of 180° between the first configuration and the second configuration.

In its first configuration illustrated in FIG. 2, the indexing ring 44 is adapted for adjusting the aperture of diaphragm 42 of the first zoom 18A.

In particular, in its first configuration, the indexing ring 44 makes visible first indexing engravings 46 specific to the first image format.

Each first indexing engraving 46 defines, for example, a specific aperture of the diaphragm 42 adapted to the first image format defined by the first zoom 18A, and in particular adapted to the size of the sensor 26A of the first rear optical device 14A.

For example, the indexing ring 44 comprises a first window 48 making the first indexing engravings 46 visible only in the first configuration of the indexing ring 44.

In its second configuration illustrated in FIG. 3, the indexing ring 44 is adapted for adjusting the aperture of diaphragm 42 of the second zoom 18B.

In particular, in its second configuration, the indexing ring 44 makes visible second indexing engravings 50 specific to the second image format. Each second indexing engraving 50 defines, for example, a specific aperture of the diaphragm 42 adapted to the second image format defined by the second zoom 18B, and in particular adapted to the size of the sensor 26B of the second rear optical device 14B.

For example, the indexing ring 44 comprises a second window 52 making the second indexing engravings 50 visible only in the second configuration of the indexing ring 44.

Advantageously, the front optical device 12 also comprises a focal engraving ring 54.

Preferably, as visible in the figures, the focal engraving ring 54 is common to the first zoom 18A and the second zoom 18B.

Preferably, the focal engraving ring 54 is movable between a first configuration illustrated in FIG. 2 and a second configuration illustrated in FIG. 3.

For example, the focal engraving ring 54 is movable in translation along the longitudinal axis X-X′ relative to the housing 34 between its first configuration and its second configuration.

In its first configuration illustrated in FIG. 2, the focal engraving ring 54 is adapted for adjusting the focal length of the first zoom 18A.

In its second configuration illustrated in FIG. 3, the focal engraving ring 54 is adapted for adjusting the focal length of the second zoom 18B.

Advantageously, the front optical device 12 also comprises a focusing ring 56.

Preferably, the focusing ring 56 is common to the first zoom 18A and the second zoom 18B.

In particular, in one example, the focusing ring 56 comprises a single configuration. The focusing ring 56 advantageously does not need to be adapted when changing between the first zoom 18A and the second zoom 18B, especially in the case where the first distance D_{A} and the second distance D_{B} are equal.

A method for changing the zoom of a camera lens will now be described.

The method comprises a first step of providing the assembly 10 forming a modular zoom.

In particular, the method for changing from the first zoom 18A illustrated in FIG. 2 to the second zoom 18B illustrated in FIG. 3 will be described.

Thus, during this first step, the front optical device 12 is coupled to the first rear optical device 14A to form the first zoom 18A.

The method then comprises a step of rotating the nut 30A of the first rear device 14A to release the first rear optical device 14A from the front optical device 12.

In particular, the nut 30A of the first rear device 14A is turned from its locking position to its free position.

Advantageously, this step of rotating the nut 30A is the only step necessary to release the first rear optical device 14A from the front optical device 12.

In particular, it is not necessary to unscrew screws to release the first rear optical device 14A from the front optical device 12.

The first rear optical device 14A is then preferably set aside from the front optical device 12.

The method is followed by a step of placing the second rear device 14B on the front optical device 12.

The method then comprises a step of rotating the nut 30B of the second rear device 14B to couple the front optical device 12 to the second rear device 14B and form the second zoom 18B.

In particular, the nut 30B of the second rear device 14B is turned from its free position to its locking position.

Advantageously, this step of rotating the nut 30B is the only step necessary to couple the second rear optical device 14B and the front optical device 12.

In particular, it is not necessary to screw screws to couple the second rear optical device 14B and the front optical device 12.

Preferably, the method comprises an additional step of rotating the indexing ring 44 of the front optical device 12 from its first configuration adapted for adjusting the aperture of the diaphragm 42 of the first zoom 18A to its second configuration adapted for adjusting the aperture of the diaphragm 42 of the second zoom 18B.

In particular, the indexing ring 44 is, for example, turned relative to the housing 34 by an angle of 180° around the longitudinal axis X-X′, so that its second window 52 makes the second indexing engravings 50 visible.

Preferably, the method also comprises an additional step of translating the focal engraving ring 54 of the front optical device 12 from its first configuration adapted for adjusting the focal length of the first zoom 18A to its second configuration adapted for adjusting the focal length of the second zoom 18B.

In particular, the focal engraving ring 54 is moved relative to the housing 34 along the longitudinal axis X-X′, for example, forward.

Advantageously, the method steps described above are the only steps necessary to change from the first zoom 18A to the second zoom 18B.

The assembly 10 forming a modular zoom according to the invention is particularly advantageous, notably thanks to the nut 30A, 30B of each of the rear devices 14A, 14B. Indeed, the nut 30A, 30B allows coupling or releasing with a single rotation step each of the rear devices 14A, 14B from the front device 12.

Furthermore, the change between the first zoom 18A and the second zoom 18B, and thus the modification of the image format, requires only a small number of steps. The modification of the image format is therefore quick and not complex. It can, in particular, be carried out without special tools, for example, outside a service center.

The person skilled in the art will understand that the previously described embodiments and variants can be combined with each other provided they are technically compatible.

1. A rear optical device intended to form an image based on an optical flux captured by a front optical device, the rear optical device comprising:
a housing comprising a sensor defining an image format, and
a coupling unit intended to removably couple the housing to a front optical device to form a zoom, the coupling unit being formed of a nut.

2. The rear optical device according to claim 1, wherein the nut is a notched nut.

3. A modular zoom assembly comprising:
a front optical device suitable for capturing an optical flux,
a first rear optical device according to claim 1, the coupling by the nut of the first rear optical device and the front optical device forming a first zoom, and
a second rear optical device according to claim 1, the coupling by the nut of the second rear optical device and the front optical device forming a second zoom.

4. The assembly according to claim 3, wherein the image format of the sensor of the first rear optical device is different from that of the second rear optical device.

5. The assembly according to claim 3, wherein the front optical device comprises an iris diaphragm and an indexing ring suitable for adjusting the aperture of the diaphragm, the iris diaphragm and the indexing ring being common to the first zoom and the second zoom.

6. The assembly according to claim 5, wherein in the first zoom, the diaphragm of the front optical device is at a first distance from the sensor of the first rear optical device.
in the second zoom, the diaphragm of the front optical device is at a second distance from the sensor of the second rear optical device, the first distance and the second distance being substantially equal.

7. The assembly according to claim 5, wherein the indexing ring is movable between a first configuration suitable for adjusting the aperture of the diaphragm of the first zoom and a second configuration suitable for adjusting the aperture of the diaphragm of the second zoom.

8. The assembly according to claim 5, wherein the front optical device comprises a focal engraving ring, the focal engraving ring being common to the first zoom and the second zoom, the focal engraving ring being movable between a first configuration suitable for adjusting the focal length of the first zoom and a second configuration suitable for adjusting the focal length of the second zoom.

9. A method for changing the zoom of a camera lens comprising the following steps:
providing an assembly according to claim 4, the front optical device being coupled to the first rear optical device to form the first zoom,
rotating the nut of the first rear device to release the first rear optical device from the front optical device, and
placing the second rear device on the front optical device and rotating the nut of the second rear optical device to couple the front optical device to the second rear optical device and form the second zoom.

10. The changing method according to claim 9, wherein the front optical device comprises an iris diaphragm and an indexing ring, the method comprising an additional step of rotating the indexing ring of the front optical device from a first configuration suitable for adjusting the aperture of the diaphragm of the first zoom to a second configuration suitable for adjusting the diaphragm opening of the second zoom;
and/or the front optical device comprises a focal engraving ring, the method comprising an additional step of translating the focal engraving ring of the front optical device from a first configuration suitable for adjusting the focal length of the first zoom to a second configuration suitable for adjusting the focal length of the second zoom.
